(19) United States
(12) Patent Application Publication
(10) Pub. No.: US 2016/0103722 A1
(43) Pub. Date: Apr. 14, 2016

(54) HARDWARE LOCKUP DETECTION MECHANISM FOR USER DEVICES

(71) Applicant: QUALCOMM Incorporated, San Diego, CA (US)

(72) Inventor: Phani Bhushan AVADHANAM, San Diego, CA (US)

(21) Appl. No.: 14/512,317

(22) Filed: Oct. 10, 2014

(51) Int. Cl. G06F 11/07

(52) U.S. Cl. CPC G06F 11/079

(57) ABSTRACT

A user device having a plurality of modules for implementing one or more use cases, maps one or more sensor outputs to a use case based on sensor outputs obtained during a hang/reset state of the user device during the use case. Each of the one or more sensor outputs is associated with one of the plurality of modules. The user device also maps one or more actions to each sensor output mapped to the use case. The one or more actions affect a change in an operating parameter of the module associated with the sensor output during a hang/rest state of the user device during the use case. The one or more actions also affect a corresponding change in the sensor output mapped to the use case.

### BACKGROUND

1. Field

The present disclosure relates generally to the detection of hardware malfunctions of user devices, and more particularly to the detection, prediction and correction of hardware lockups of user devices.

2. Background

User devices, such as laptops, smartphones, net books, tablets, etc, may experience hardware lockups and subsequent failures in the lower level software, which causes unpleasant user experience. “Hardware lockup” as used herein refers to situations where a user device enters a hang condition or a power reset condition due to hardware issues. Hardware lockups are distinct from software lockups, wherein device operation may freeze due to software issues.

A “hang” condition refers to a condition where the device is powered up but no longer functioning for reasons related to hardware. For example, a hardware lockup of a video module may cause the device display to freeze during playback of a video. More specifically, a hang of the video module may result in a subsequent failure in the lower level video playback software leading to the screen freeze. If the user leaves the device as it is when the situation happens, the device will not reset, nor will the device come out of the situation by itself. In this case, the user may have to remove the device battery or push a device button long enough to cause a power reset. If left untouched, the device will remain in a hang condition indefinitely or until the battery is completely discharged.

A “power reset” condition refers to a condition wherein a power management module of a user device determines to initiate a power reset of the user device. For example, the power management module may detect an abnormal condition, such as an insufficient current supply to a hardware component. Upon detection of the condition, the power management module may cause a trip in the power circuitry of the user device to thereby reset the entire user device by turning the user device off and then back on.

Existing user devices suffer from inefficient use of hardware resources. For example, if one hardware module is the source of the lockup, the entire circuitry is reset for recovery.

### SUMMARY

In an aspect of the disclosure, a method, a computer program product, and an apparatus are provided. An apparatus, e.g., user device, has a plurality of modules for implementing one or more use cases. The user device maps one or more sensor outputs to a use case based on sensor outputs obtained during a hang/reset state of the user device during the use case. Each of the one or more sensor outputs is associated with one of the plurality of modules. The user device also maps one or more actions to each sensor output mapped to the use case. The one or more actions affect a change in an operating parameter of a module associated with the sensor output mapped to the use case during a hang/rest state of the user device during the use case. The one or more actions also affect a corresponding change in the sensor output mapped to the use case.

### BRIEF DESCRIPTION OF THE DRAWINGS

FIG. 1 is a block diagram of a user device configured to collect, process and refine information related to lockups of hardware modules or components of the device, and to predict potential lockups and take corrective actions to avoid such lockups.

FIG. 2 is a flow chart of a method of operating the user device of FIG. 1.

FIG. 3 is a flow chart of a method of mapping sensor outputs to use cases.

FIG. 4 is a flow chart of a method of mapping corrective actions to sensor outputs.

FIG. 5 is a flow chart of a method of predicting hardware lockups and implementing corrective actions.

FIG. 6 is an illustration of database entries related to a use case.

FIG. 7 is a block diagram illustrating the modules/means/components of a user device that implements the method of FIG. 2.

FIG. 8 is a diagram illustrating a hardware implementation for a user device employing a processing system to implement the method of FIG. 2.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of detecting, predicting and correcting hardware lockups of user devices are presented below with reference to various apparatuses and methods. These apparatuses and methods are described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer.

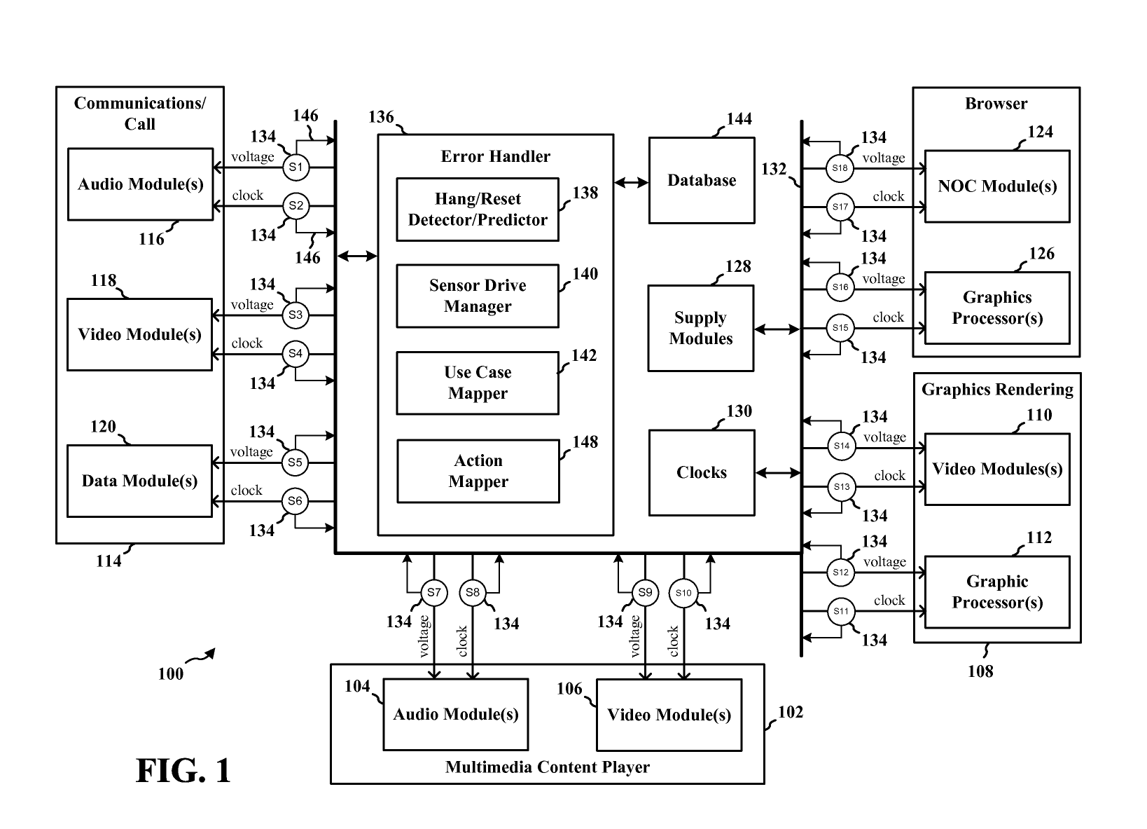

FIG. 1 is a block diagram of a user device 100 configured to collect, process and refine information related to lockups of hardware modules or components of the device, and to predict potential lockups and take corrective actions to avoid such lockups. The user device 100 may be, for example, a desktop computer, a laptop computer, or a wireless device, such as a smart phone, a net book or a tablet.

The user device 100 may include various hardware components or modules supporting various functionalities or use cases of the device. For example, a multimedia content player function 102 may rely on one or more audio modules 104, such as DSP module, Low Power Audio module, SLIM Bus interface, and one or more video modules 106, such as Video Core, Venus Video driver, Shared Memory manager. A graphics rendering function 108 may rely on one or more video modules 110, such as Adreno Graphics Core, VBIF interface module, and one or more graphics processors 112. A communication/call function 114 may rely on one or more audio modules 116, one or more video modules 118 and one or more data modules 120. A browser function 122 may rely on one or more modules 124, 126, such as a network operations center (NOC) module, a central processing unit, e.g. KRAIT processor, an Adreno Graphics Processor.

The user device 100 also includes operation modules 128, 130, that provide operation parameters to the functional modules 104, 106, 110, 112, 116, 118, 120, 124, 126. The operational modules may include one or more supply modules 128 that supply voltages to the functional modules 104, 106, 110, 112, 116, 118, 120, 124, 126, and one or more clocks 130 that supply clock signals to the functional modules. One or more busses 132 interconnect the various functional and operation modules.

In accordance with embodiments disclosed herein, the user device 100 includes various sensors 134 located at various points of interest of the device, and an error handler 136 configured to collect, process and validate information related to lockups of hardware modules of the device, and to predict potential lockups and take corrective actions to avoid such lockups. In one implementation, voltage sensors S1, S3, S5, S7, S9, 511, S13, S15 and S17 may be located on a printed circuit board of the device at locations corresponding to an input point where a functional module 104, 106, 110, 112, 116, 118, 120, 124, 126 receives its power. These sensors 134 may be configured to sense the voltage being supplied to the modules and to provide a measure of the voltage to the bus 132. In another implementation, clock sensors S2, S4, S6, S8, S10, S12, S14, S16 and S18 may be located on a printed circuit board of the device at locations corresponding to an input point where a functional module 104, 106, 110, 112, 116, 118, 120, 124, 126 receives its clock signal. These sensors 134 may be an edge/level detect sensor configured to detect the physical characteristics, e.g. amplitude, of the clock input signal being supplied to the module.

In one aspect, the user device 100 is configured to collect and process sensor outputs 146 to build a database of knowledge related to the operational conditions of the device during hardware lockups of the device. To this end, the error handler 136 includes a hang/reset detector/predictor 138. The hang/reset detector/predictor 138 may be included as part of the software operating system of the device 100. For example, the hang/reset detector/predictor 138 may be a software module of a high level operating system, such as Windows Phone, Linux, Android, MeeGo, Chrome, RIM QNX, BREW MP and Apple's iOS.

The hang/reset detector/predictor 138 is configured to detect for either of a hang condition or a power reset condition. These conditions may be detected using any of several known methods such as: invocation of panic handler, invocation of HW reset module, or invocation of corruption handler. This may be done using the sensors/detectors strategically placed on all the points on the printed circuit board surface, buses and hardware pin points, where internal modules will be powered from. Whenever the software/operating system detects a hang/device shut down or error condition, a complete dump of these sensor outputs 146 is taken by the error handler 136 and stored in a database 144.

The hang/reset detector/predictor 138 is also configured to predict a potential hang/reset. To this end, the hang/reset detector/predictor 138 may obtain sensor outputs 146 corresponding to the use case of the device at a particular time. The sensor outputs 146 may be compared to corresponding information in the database 144. For example, the sensor outputs 146 may be compared to expected sensor outputs during normal operation, of the device during the particular use case. If the difference is greater than a threshold value, the hang/reset detector/predictor 138 may conclude that a hang/reset may occur. Alternatively, the difference between the sensor output and the expected sensor output may be determined and compared to a vector weight of the sensor output. If the difference is within a threshold value of the vector weight, the hang/reset detector/predictor 138 may conclude that a hang/reset may occur.

The error handler 136 also includes a sensor drive manager 140. The sensor drive manager 140 may be included as part of the software operating system of the device 100. The sensor drive manager 140 is configured to trigger one or more of the sensors 134 to provide sensor outputs 146 corresponding to the operation parameter, e.g., supply voltage, clock signal, being sensed by the sensor. Such triggering may be in response to a detection of a hang or power set by the hang/reset detector 138 or may be periodic during normal operation of the device. Upon being triggered, the one or more sensors 134 provide sensor outputs 146 to the sensor drive manager 140 over the bus 132. In one implementation, the sensor drive manager 140 triggers outputs from all sensors 134; thus providing a data dump of sensor outputs 146 from all available sensors 134. In other implementations, the sensor drive manager 140 may trigger a subset of sensors 134 to provide sensor outputs 146. For example, depending on the function being performed, i.e., the use case, of the device at the time of hang/reset, the sensor drive manger 140 may only trigger sensor outputs 146 from those sensors 134 associated with functional modules 104, 106, 110, 112, 116, 118, 120, 124, 126 that implement the use case.

The error handler 136 may also include a use case mapper 142. The use case mapper 142 may be included as part of the software operating system of the device 100. The use case mapper 142 is configured to determine the use case the device 100 is in at the time of the detected hang/reset, and to associate or map one or more of the sensor outputs 146 obtained as a result of the hang/reset with the determined use case. Software of the use case mapper 142 determines the use case of the device using the code path execution for a given module. If a code snippet is being executed using the assembly instructions based on the physical address of the instruction cache, the module knows where the control is. This physical address information may be analyzed with respect to the executable and linkable format (ELF) image or SW image that is flashed on the device. Together they provide accurate use case information from the software that is tracking the use cases. The use case mapper 142 provides the use case information and corresponding sensor outputs 146 to a database 144.

Use cases may be, for example, a communication/call use, e.g., audio call, video call, data call, performed by communication/call 114 modules; a browser use performed by browser 122 modules; a multimedia-content-play use performed by player 102 modules, or a graphics-rendering use performed by graphics rendering 108 modules. Examples of specific use cases include:

Voice call over 4G live network @ −85 dBm

4G Standby

4G+WIFI+BT standby

4G Talk with BT

Email Sync over 4G

3G Standby

3G+WIFI+BT standby

SMS Receive

Email Sync over 3G

Email Sync over WiFi

Voice call over 3G live network @ −85 dBm

5 MB File Upload over 3G live network @ −85 dBm

5 MB File Download over 3G live network @ −85 dBm

Background data sync over 3G live network @ −85 dBm

10 KB Email Send over 3G

Email Compose at 1 char per 500 msec in 3G mode

MP3 @ 44.1 kHz 128 kbps Stereo in 3G mode

Audio Streaming MP3 @ 44.1 kHz 128 kbps Stereo over 3G

1080p H.264 20 Mbps AAC+ Video Playback in 3G mode

720p H.264 2.3 Mbps AAC+Video Streaming over Wi-Fi in 3G mode

1080p 20 Mbps H264 AAC+30 fps Video encode in 3G mode

Camera Snapshot @ Max supported resolution in 3G mode

HQ Video call (Skype) over Wi-Fi in 3G mode

Static image display in 3G mode

Powerlift Scene6 30 fps in 3G mode

Egypt Scene57 30 fps in 3G mode

Browser (30 sec refresh rate) over 3G live network @ −85 dBm

Browser (30 sec refresh rate) over Wi-Fi in 3G mode

Address look-up using Maps over 3G live network @ −85 dBm

Scroll 10 pages/scroll every 10 sec in 3G mode

Voice Search over 3G live network @ −85 dBm

5 MB File Upload over 4G live network @ −85 dBm

5 MB File Download over 4G live network @ −85 dBm

Background data sync over 4G live network @ −85 dBm

10 KB Email Send over 4G

Email Compose at 1 char per 500 msec in 4G mode

MP3 @ 44.1 kHz 128 kbps Stereo in 4G mode

Audio Streaming MP3 @ 44.1 kHz 128 kbps Stereo over 4G

1080p H.264 20 Mbps AAC+Video Playback in 4G mode

720p H.264 2.3 Mbps AAC+Video Streaming over Wi-Fi in 4G mode

1080p 20 Mbps H264 AAC+30 fps Video encode in 4G mode

Camera Snapshot 30 fps @ Max supported resolution in 4G mode

HQ Video call (Skype) over Wi-Fi in 4G mode

Static image display in 4G mode

Powerlift Scene6 30 fps in 4G mode

Egypt Scene57 30 fps in 4G mode

Browser (30 sec refresh rate) over 4G live network @ −85 dBm

Browser (30 sec refresh rate) over Wi-Fi in 4G mode

Address look-up using Maps over 4G live network @ −85 dBm

Scroll 10 pages/scroll every 10 sec in 4G mode

Voice Search over 4G live network @ −85 dBm

3G Talk with BT

5 MB File Download over 3G live network @ −85 dBm in W+G mode

The use case mapper 142 may determine the most relevant sensor outputs 146 for a use case and map those sensor outputs to the use case. For example, upon a hang/rest during a particular use case, the use case mapper 142 may obtain sensor outputs 146 from all sensors 134 and compare these sensor outputs to baseline sensor outputs previously obtained during normal operation of the device. These baseline sensor outputs 146 may be stored in the database 144. For each obtained sensor output, the use case mapper 142 may assign a weight to the sensor output based on the difference between the baseline sensor output and the hang/reset sensor output, wherein larger weights are assigned to sensor outputs 146 having larger differences between baseline and hang/reset outputs. In one configuration, the weight corresponds to a vector difference between baseline and hang/reset outputs. For each sensor output, the use case mapper 142 may assign a rank based on the weight of the sensor output relative to the weights of other sensor outputs 146, wherein sensors are ranked in order from highest to lowest based on corresponding largest to smallest weight.

Overtime, the use case mapper 142 may identify those sensor outputs 146 most affected during a use case hang/reset. Such identification may be based on previously determines weights and ranks of sensor outputs 146. For example, those sensor outputs 146 having a weight above a threshold value for a specific use case hang/rest may be identified as relevant sensor outputs for the use case. A mapping of these identified sensor outputs 146 to the specific use case is maintained in the database 144.

During a subsequent hang/reset during a specific use case, the use case mapper 142 may trigger sensor outputs 146 only for those sensor outputs mapped to the specific use case. For each sensor output, the use case mapper 142 may adjust the weight and rank to the sensor output based on the difference between the baseline reading and the hang/reset reading of the sensor, and update the database 144 accordingly. The foregoing establishes a database of use-case-to-sensor-output mappings along with expected sensor readings during normal operation and weights and ranks associated with sensor outputs 146 during a hang/rest during the use case.

In another aspect, the user device 100 is configured to associate potential corrective actions to the sensor outputs 146 mapped to use case. To this end, the error handler 136 further includes an action mapper 148. In response to a detected hang/reset, the action mapper 148 may implement an action in an attempt to prevent a hang/reset. Such actions may include adjustment of the voltage or the clock signal being supplied to the module associated with the sensor output.

Upon implementing the action, the action mapper 148 obtains sensor outputs 146 mapped to the use case and compares the outputs to corresponding information in the database 144 to determine if the action has improved the stability of the device. For example, the sensor output may be compared to the expected output during normal operation, of the device during the particular use case. If the difference is now less than a threshold value, the action mapper 148 may conclude that device stability has improved and a hang/reset is not likely to occur. Alternatively, the difference between the sensor output and the expected output may be determined and compared to a vector weight of the sensor. If the difference is not within a threshold value of the vector weight, the action mapper 148 may conclude that device stability has improved and a hang/reset is not likely to occur.

If the action does not result in improved stability of the device, the action mapper 148 may implement another action, such as a further adjustment of voltage supply and/or clock signal, and repeat the foregoing process to determine if stability is improved. During this iterative process, information corresponding to the actions taken and the affect on stability is maintained in the database. For example, each of the actions mapped to a use case may be maintained in the database along with a corresponding ranking indicative of the affect of the action, with the most effective action having the highest ranking Upon a subsequent hang/reset, or predicted hang/reset, during the use case, the action mapper 148 may implement one or more actions based on the information stored in the database. The information stored in the database may be, for example, a specific voltage value or clock timing setting for the component associated with the sensor, or a change, e.g., increase or decrease, in such setting.

The foregoing adjustment and feedback process may be individually performed for each sensor output associated with a particular use case. As a result of these individual processes each sensor output may be assigned a rank based on its effect on device stability. For example, a particular use case may have five sensors mapped to it by the use case mapper 142. The action mapper 148 may determine that actions associated with one or more of these sensors outputs have no impact on device stability when the device hangs/resets upon such adjustment, and may accordingly disassociate these sensor outputs 146 with the use case.

For other sensors, the action mapper 148 may determine that actions associated with the sensor outputs 146 improve device stability, in that the action results in the device not hanging/resetting. For these sensor outputs 146, particular actions are ranked as to whether the action worked. For example, if a first action corresponding to a first adjustment of voltage supply to a component associated with a sensor output does not result in avoidance of a hang/reset, that first action is ranked lower than a second action corresponding to a second adjustment that resulted in avoidance of a hang/reset.

In another aspect, the user device 100 is configured to periodically monitor sensor outputs 146 and predict potential hardware lockups based on sensor information stored in the database. To this end, the sensor drive manager 140 triggers sensor outputs 146 at intervals of, for example, every 5 seconds. At the time of trigger, the sensor drive manager 140 may determine the use case of the device as described above. The hang/reset detector/predictor 138 processes the sensor outputs 146 as described above to determine if a hang/reset may occur. If a potential hang/reset is detected, the action mapper 144 implements one or more actions mapped to the use case in order to prevent the hang/reset. The action mapper 144 may implement actions one at a time based on the sensor output weights and rankings. For example, the highest ranked actions associated with the highest weighted sensor output may be implemented first. If that action does not improve device stability, the next highest ranked action associated with the action with the highest weighted sensor output may be implemented next. This process may be repeated until an implemented action improves device stability.

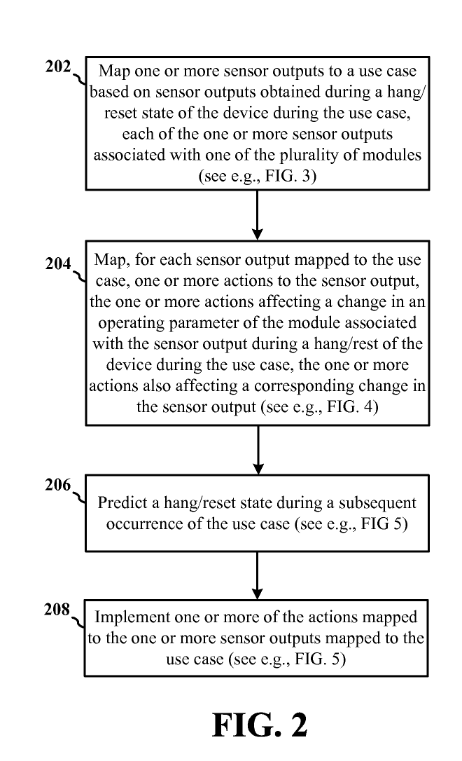

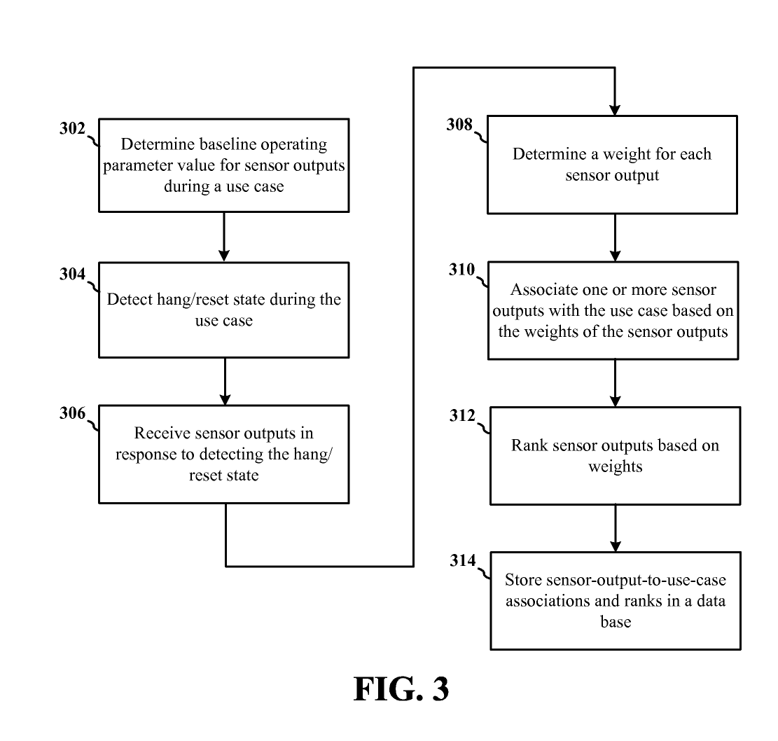

FIG. 2 is a flow chart of a method of collecting and processing sensor outputs for purposes of predicting potential device hardware lockup and implementing corrective actions to avoid such lockups. The method may be performed by a user device, such as the device of FIG. 1. At step 202, the user device maps one or more sensor outputs 146 to a use case based on sensor outputs obtained during a hang/reset state of the device during the use case. Each of the one or more sensor outputs 146 is associated with one of the plurality of modules. FIG. 3 is a flow chart of an example method of mapping sensor outputs to use cases (step 202).

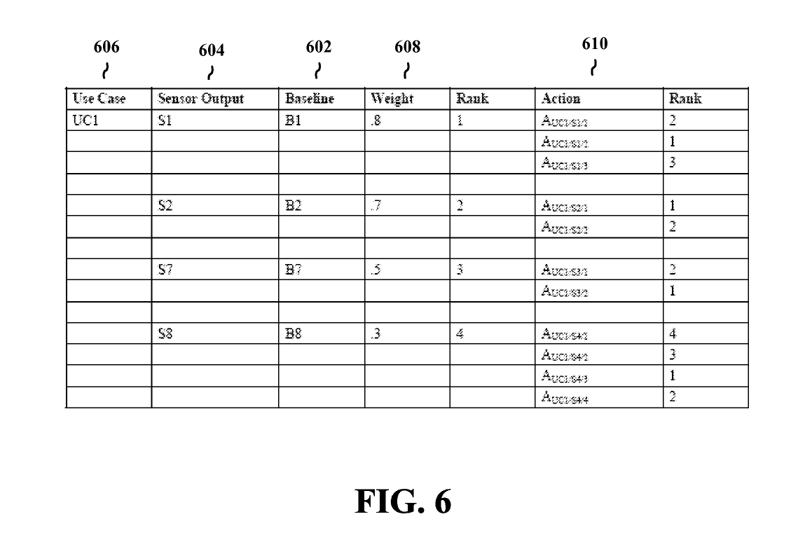

With reference to FIG. 3, in step 302, the user device may determine baseline operating parameter value for sensor outputs 146 during a use case. To this end, the sensor drive manager 140 may obtain sensor outputs 146 from all available sensors 134 during normal operation of the device during the use case, or a subset of all available sensors 134. These baseline values may be stored in the database 144 and mapped to the use case. For example, with reference to FIG. 6, a database may include baseline values 602 for each sensor output 604 associated with a use case 606.

At step 304 the user device may detect a hang/reset state during the use case. For example, the hang/reset detector/predictor 138 may detect a hang or reset condition using any of several known methods such as: invocation of panic handler, invocation of hardware reset module, or invocation of corruption handler, as described above.

At step 306 the user device receives sensor outputs 146 in response to detecting the hang/reset state. To this end, the sensor drive manager 140 may obtain sensor outputs 146 from all available sensors 134 during the use case.

At step 308 the user device determines a weight for each sensor output 146. To this end, the use case mapper 142 may obtain the baseline sensor output for each sensor output from the database 144 and determine a difference between the baseline sensor output and the received sensor output. For example, with reference to FIG. 6, during use case UC1, the use case mapper 142 may determine a weight 608 for each of sensor outputs S1, S2, S7 and S8.

At step 310 the user device associates one or more sensor outputs 146 with the use case based on the weights of the sensor outputs. To this end, the use case mapper 142 may associate sensor outputs 146 having a weight that satisfies a mapping criterion, to the use case. A mapping criterion may be a threshold value, for example sensors placed for voltage detection at a video core can obtain a ceiling voltage read from the sensor and divide it by the maximum allowed value of voltage at that point. This threshold or weight can range from −1 thru +1 and those sensor outputs 146 having a weight above the threshold value may be identified as relevant sensor outputs for the use case. A mapping of these identified sensor outputs 146 to the specific use case is maintained in the database 144. For example, with reference to FIG. 6, during use case UC1, the use case mapper 142 may determine that sensor outputs S1, S2, S7 and S8 satisfy the mapping criterion. Accordingly, these sensor outputs are mapped to use case UC1.

At step 312 the user device ranks sensor outputs 146 based on weights. For example, with reference to FIG. 6, based on the respective weights of S1, S2, S7 and S8, the use case mapper 142 may determine a rank 1 for S1, a rank 2 for S2, a rank 3 for S7 and a rank 4 for S8. At step 314 the user device may store sensor-output-to-use-case associations and related weights and ranks in the database.

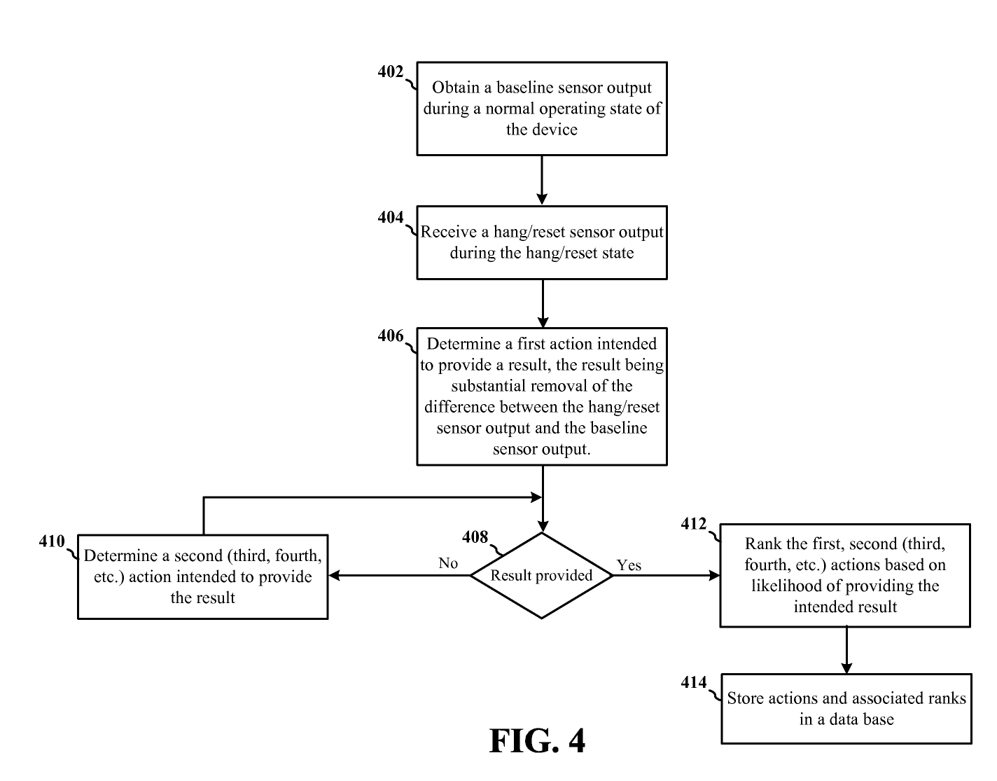

Returning to FIG. 2, at step 204, the device maps, for each sensor output mapped to the use case, one or more actions to the sensor output. The one or more actions affect a change in an operating parameter of the module associated with the sensor output during a hang/rest of the device during the use case. The one or more actions also affect a corresponding change in the sensor output. FIG. 4 is a flow chart of an example method of mapping actions to sensor outputs (step 204).

With reference to FIG. 4, in step 402, the user device obtains a baseline sensor output corresponding to an operating parameter during a normal operating state of the device. To this end, the action mapper 144 may obtain the baseline sensor output for each sensor output mapped to the use case. These baseline outputs may be obtained from the database 144.

At step 404 the user device receives a hang/reset sensor output during the hang/reset state. To this end, the action mapper 144 may receive sensor outputs 146 from those sensor outputs mapped to the use case. For example, with reference to FIG. 6, in the case of a hang/reset during use case UC1, the sensor drive manager 140 may receive sensor outputs S1, S2, S7 and S8.

At step 406 the user device determines a first action intended to provide a result, the result being improved device stability that may result in avoidance of the hang/reset in the future. For example, due to the hang/reset state of the device, a difference between the hang/reset sensor output received by the action mapper 144 and the corresponding baseline sensor output may be expected. An action that removes this difference, accordingly, may be considered to provide improved device stability and thereby may result in avoidance of a hang/reset during a future occurrence of the use case. In cases where the operating parameter is a supply voltage or current, the first action may be an increase in the supply by a first amount. In cases where the operating parameter is a clock signal, the first action may be one of a ramp up or ramp down in by a first amount. The amount may be percentage defined as a change in clock amplitude divided by current clock level amplitude.

At step 408 the device determines if the intended result was provided. To this end, upon a subsequent prediction of a hang/reset during the use case, the device may implement the first action mapped to the use case and detect for a hang/reset. If a hang/reset occurs then the desired result is not provided, and the method proceeds to step 410, where the user device determines a second (third, fourth, etc.) action intended to provide the result. In cases where the operating parameter is a supply voltage or current, the second action may be an increase in the supply by a second amount. In cases where the operating parameter is a clock signal, the action may be one of a ramp up or ramp down by a second amount corresponding to a percentage change with respect to change in clock amplitude divided by the current clock level amplitude. Steps 408 and 410 are repeated until an action provides the intended result.

Returning to step 408, if a hang/reset does not occur then the desired result is provided, and the method proceeds to step 412, where the user device ranks the first, second (third, fourth, etc.) actions based on likelihood of providing the intended result. As for different actions that may result in no hang/reset, granularity between different actions may be determined and actions ranked accordingly. This may be done using the following granular approach: An action is made up of series of sub actions. If an action resulted in a desired result, the entire subset of sub actions will be ranked better. On the other hand if an action did not result in a desired output, then the entire subset of sub-actions will be ranked accordingly. Next time an action is being put together, these sub-actions will be weighed accordingly.

At step 414 the user device stores actions and associated ranks in a database 144. For example, with reference to FIG. 6, for use case UC1, the action mapper 144 may determine, process, and store three different actions 610 A_{UC1/S1/1}, A_{UCI/S1/2} and A_{UC1/S1/3} related to sensor output S1, two different actions A_{UC1/S2/1} and A_{UCI/S2/2} related to S2, two different actions A_{UC1/S7/1} and A_{UCI/S7/2} related to S7 and four different actions A_{UC1/S8/1}, A_{UCI/S8/2}, A_{UC1/S8/3} and A_{UC1/S8/4} related to S8.

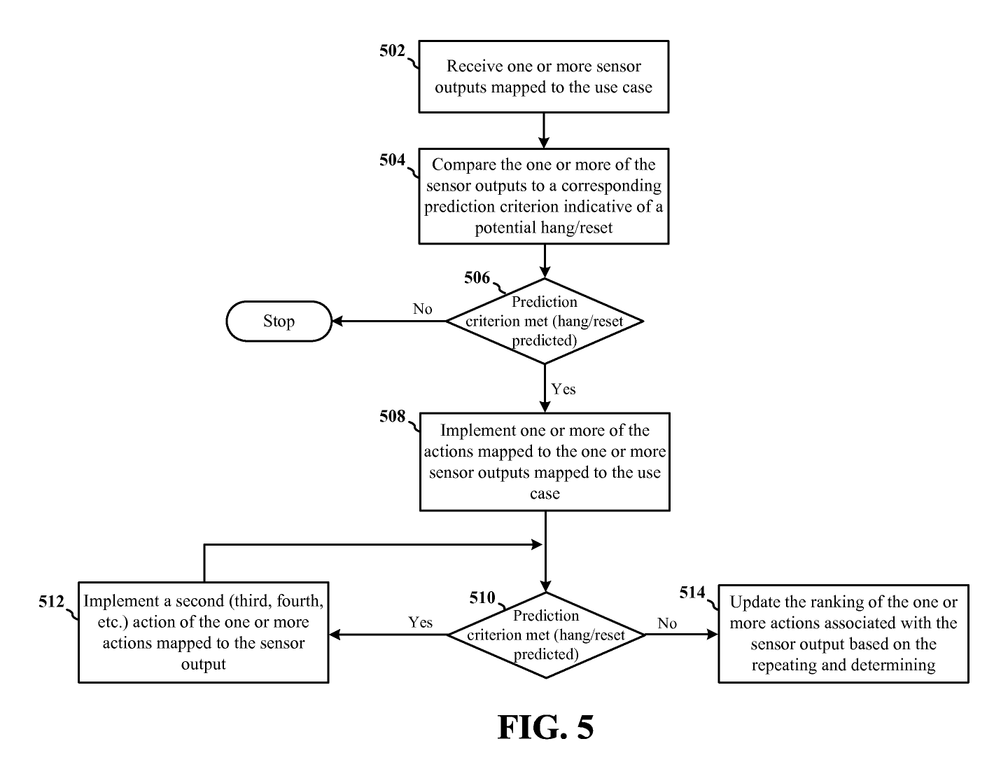

Returning to FIG. 2, at step 206, subsequent to mapping one or more sensor outputs 146 and mapping one or more actions, the device predicts a hang/reset state during a subsequent occurrence of the use case. At step 208, upon predicting a hang/rest, the device implements one or more of the actions mapped to the one or more sensor outputs 146 mapped to the use case. FIG. 5 is a flow chart of an example method of predicting and implementing (steps 206 and 208).

With reference to FIG. 5, in step 502, the user device receives one or more sensor outputs 146 mapped to the use case. To this end, the sensor drive manager 140 may determine the sensor outputs 146 associated with the use case based on information included in the database 144, and trigger the appropriate sensors 134 to receive the sensor outputs 146 mapped to the use case.

At step 504 the user device compares the one or more of the sensor outputs 146 to a corresponding prediction criterion indicative of a potential hang/reset. To this end, the hang/reset detector/predictor 138 may determine whether a difference between a sensor output and its corresponding baseline exceeds a threshold value.

At step 506 the hang/reset detector/predictor 138 determines if the prediction criterion is met. In other words, the hang/reset detector/predictor 138 predicts whether the device is likely to hang or reset. If the prediction criterion is not met, meaning the device is not predicted to hang or reset, the method stops. If, however, the prediction criterion is met, meaning the device is predicted to hang or reset, the method proceeds to step 508, where the user device implements one or more of the actions mapped to the one or more sensor outputs 146 mapped to the use case.

At step 510 the hang/reset detector/predictor 138 again determines if the prediction criterion is met. If the prediction criterion is met, meaning the device is still predicted to hang or reset, the method proceeds to step 512, where the user device implement a second (third, fourth, etc.) action of the one or more actions mapped to the sensor output. Steps 510 and 512 are repeated until the prediction criterion is not met. At step 514 the user device updates the ranking of the one or more actions associated with the sensor output based on the repeating and determining.

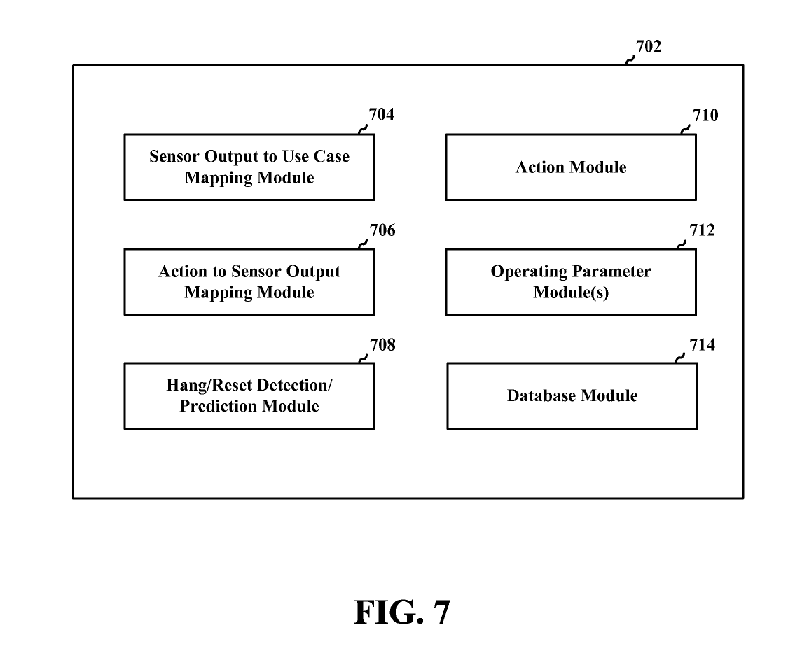

FIG. 7 is a block diagram illustrating the modules/means/components of a user device that implements the methods of FIGS. 2-5. The apparatus includes a sensor-output-to-use-case mapping module 704, an action-to-sensor-output mapping module 706, a hang/reset detection/prediction module 708, an action module 710, one or more operating parameter module(s) 712, and a database module 714.

The sensor-output-to-use-case mapping module 704 maps one or more sensor outputs 146 to a use case based on sensor outputs obtained during a hang/reset state of the device during the use case. Each of the one or more sensor outputs 146 is associated with one of the plurality of modules. The action-to-sensor-output mapping module 706 maps, for each sensor output mapped to the use case, one or more actions to the sensor output. The one or more actions affect a change in an operating parameter of the module associated with the sensor output during a hang/rest of the device during the use case. The one or more actions also affect a corresponding change in the sensor output.

The hang/reset detection/prediction module 708 predicts and detects for a hang/reset state during use cases. The action module 710 implements one or more of the actions mapped to the one or more sensor outputs mapped to the use case. The one or more operating parameter module(s) 712 supply operating parameters, e.g., voltage, clock signals, etc., to functional modules of the device. The database module 714 stores information that maps sensor output and actions to use cases.

The apparatus may include additional modules that perform each of the steps of the algorithm in the aforementioned flow charts of FIGS. 2-5. As such, each step in the aforementioned flow charts of FIGS. 2-5 may be performed by a module and the apparatus may include one or more of those modules. The modules may be one or more hardware components specifically configured to carry out the stated processes/algorithm, implemented by a processor configured to perform the stated processes/algorithm, stored within a computer-readable medium for implementation by a processor, or some combination thereof

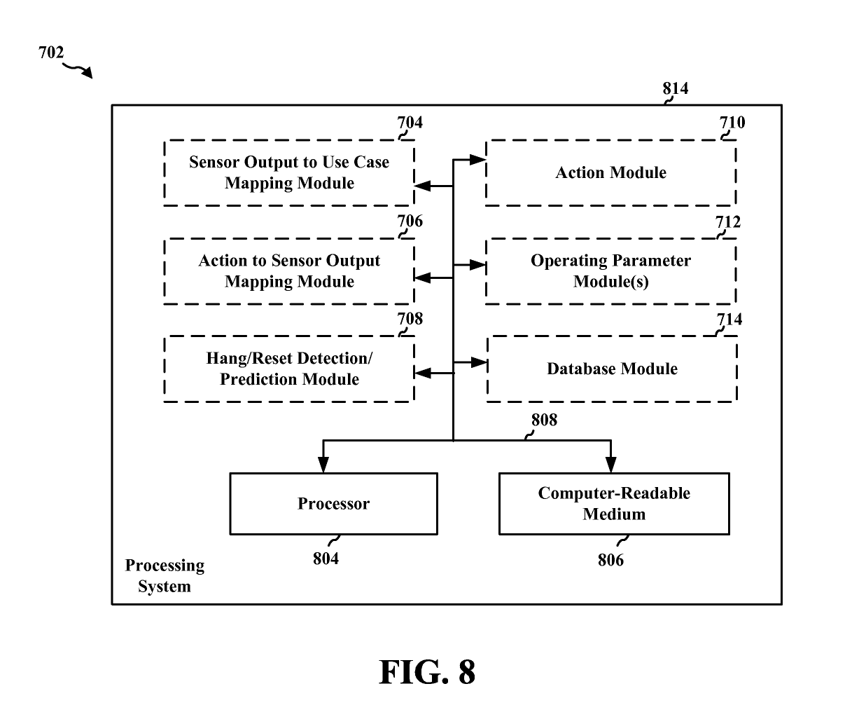

FIG. 8 is a diagram illustrating a hardware implementation for a user device employing a processing system 814 to implement the methods of FIGS. 2-5. The processing system 814 may be implemented with a bus architecture, represented generally by the bus 808. The bus 808 may include any number of interconnecting buses and bridges depending on the specific application of the processing system 814 and the overall design constraints. The bus 808 links together various circuits including one or more processors and/or hardware modules, represented by the processor 804, the modules 704, 706, 708, 710, 712 and 714 and the computer-readable medium 806. The bus 808 may also link various other circuits such as timing sources, peripherals, voltage regulators, and power management circuits, which are well known in the art, and therefore, will not be described any further.

The processing system 814 includes a processor 804 coupled to a computer-readable medium 806. The processor 804 is responsible for general processing, including the execution of software stored on the computer-readable medium 806. The software, when executed by the processor 804, causes the processing system 814 to perform the various functions described supra for any particular apparatus. The computer-readable medium 806 may also be used for storing data that is manipulated by the processor 804 when executing software. The processing system further includes at least one of the modules 704, 706, 708, 710, 712, and 714. The modules may be software modules running in the processor 804, resident/stored in the computer readable medium 806, one or more hardware modules coupled to the processor 804, or some combination thereof.

In one configuration, the user device 702 includes means for mapping one or more sensor outputs 146 to a use case based on sensor outputs obtained during a hang/reset state of the device during the use case, each of the one or more sensor outputs associated with one of the plurality of modules; and means for mapping, for each sensor output mapped to the use case, one or more actions to the sensor output, the one or more actions affecting a change in an operating parameter of the module associated with the sensor output during a hang/rest of the device during the use case, the one or more actions also affecting a corresponding change in the sensor output. The apparatus may further include means for predicting a hang/reset state during a subsequent occurrence of the use case, subsequent to mapping one or more sensor outputs and mapping one or more actions; and means for implementing one or more of the actions mapped to the one or more sensor outputs mapped to the use case upon predicting a hang/rest. The aforementioned means may be one or more of the aforementioned modules of the apparatus 702 and/or the processing system 814 of the apparatus 702′ configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method of operating a user device having a plurality of modules for implementing one or more use cases, said method comprising:
mapping one or more sensor outputs to a use case based on sensor outputs obtained during a hang/reset state of the user device during the use case, each of the one or more sensor outputs associated with one of the plurality of modules; and
mapping one or more actions to each sensor output mapped to the use case, wherein the one or more actions affect a change in an operating parameter of a module associated with the sensor output mapped to the use case during a hang/rest state of the user device during the use case, and the one or more actions affect a corresponding change in the sensor output mapped to the use case.

2. The method of claim 1, wherein mapping one or more sensor outputs to a use case comprises:
detecting the hang/reset state during the use case;
receiving one or more sensor outputs in response to detecting the hang/reset state;
determining a weight for each of the one or more sensor outputs; and
associating each of the one or more sensor outputs with the use case based on the weight of the sensor output.

3. The method of claim 2, wherein determining a weight for each of the one or more sensor outputs comprises:
obtaining a baseline sensor output for each of the one or more sensor outputs during a normal operating state of the user device during the use case; and
determining for each of the one or more sensor outputs a difference between the baseline sensor output and the received sensor output.

4. The method of claim 3, wherein each of the one or more sensor outputs having a weight that satisfies a mapping criterion is associated with the use case.

5. The method of claim 3, further comprising:
ranking the one or more sensor outputs mapped to the use case based on the weights associated with each of the one or more sensor outputs.

6. The method of claim 1, wherein mapping one or more actions to each sensor output mapped to the use case comprises, for each sensor output:
obtaining a baseline sensor output during a normal operating state of the user device;
receiving a hang/reset sensor output during the hang/reset state, the hang/reset sensor output being different from the baseline sensor output; and
determining a first action intended to provide an intended result, the intended result being substantial removal of a difference between the hang/reset sensor output and the baseline sensor output.

7. The method of claim 6, further comprising:
determining if the first action provided the intended result; and
determining a second action intended to provide the intended result when the first action did not provide the intended result.

8. The method of claim 7, further comprising ranking the first action and the second action based on a likelihood of providing the intended result.

9. The method of claim 7, wherein the operating parameter comprises a supply voltage or current, and the determined first action comprises an increase in the supply voltage or current by a first amount and the determined second action comprises an increase in the voltage or current supply by a second amount different from the first amount.

10. The method of claim 7, wherein the operating parameter comprises a clock signal, and the determined first action comprises one of a ramp up or a ramp down in clock amplitude by a first amount and the determined second action comprises one of a ramp up or a ramp down in clock amplitude by a second amount different from the first amount.

11. The method of claim 1, further comprising:
subsequent to mapping one or more sensor outputs to a use case, and mapping one or more actions to each sensor output mapped to the use case, predicting a hang/reset state during a subsequent occurrence of the use case; and
upon predicting a hang/rest state, implementing one or more of the actions mapped to the one or more sensor outputs mapped to the use case.

12. The method of claim 11, wherein predicting a hang/reset state comprises:
receiving one or more sensor outputs mapped to the use case;
comparing the one or more of the sensor outputs to a prediction criterion indicative of a potential hang/reset state; and
determining a potential hang/reset state when the prediction criterion is satisfied.

13. The method of claim 12, wherein a first action of the one or more actions mapped to a sensor output is implemented when the prediction criterion is satisfied.

14. The method of claim 13, further comprising:
determining if implementation of the first action affected a change in the sensor output so that the prediction criterion is no longer satisfied;
implementing a second action of the one or more actions mapped to the sensor output when the prediction criterion is still satisfied; and
repeating the determining and implementing until the prediction criterion is no longer satisfied.

15. A user device having a plurality of modules for implementing one or more use cases, said user device comprising:
a memory; and
at least one processor coupled to the memory and configured to:
map one or more sensor outputs to a use case based on sensor outputs obtained during a hang/reset state of the user device during the use case, each of the one or more sensor outputs associated with one of the plurality of modules; and
map one or more actions to each sensor output mapped to the use case, wherein the one or more actions affect a change in an operating parameter of a module associated with the sensor output mapped to the use case during a hang/rest state of the user device during the use case, and the one or more actions affect a corresponding change in the sensor output mapped to the use case.

16. The user device of claim 15, wherein the at least one processor maps one or more sensor outputs to a use case by being configured to:
detect the hang/reset state during the use case;
receive one or more sensor outputs in response to detecting the hang/reset state;
determine a weight for each of the one or more sensor outputs; and
associate each of the one or more sensor outputs with the use case based on the weight of the sensor output.

17. The user device of claim 16, wherein that at least one processor determines a weight for each of the one or more sensor outputs by being further configured to:
obtain a baseline sensor output for each of the one or more sensor outputs during a normal operating state of the user device during the use case; and
determine for each of the one or more sensor outputs, a difference between the baseline sensor output and the received sensor output.

18. The user device of claim 17, wherein each of the one or more sensor outputs having a weight that satisfies a mapping criterion is associated with the use case.

19. The user device of claim 17, wherein the at least one processor maps one or more sensor outputs to a respective use case by being further configured to:
rank the one or more sensor outputs mapped to the use case based on the weights associated with each of the one or more sensor outputs.

20. The user device of claim 15, wherein the at least one processor maps one or more actions to each sensor output mapped to the use case by being configured to, for each sensor output:
obtain a baseline sensor output during a normal operating state of the user device;
receive a hang/reset sensor output during the hang/reset state, the hang/reset sensor output being different from the baseline sensor output; and
determine a first action intended to provide an intended result, the intended result being substantial removal of a difference between the hang/reset sensor output and the baseline sensor output.

21. The user device of claim 20, wherein the at least one processor maps one or more actions to the sensor output by being further configured to:
determine if the first action provided the intended result; and
determine a second action intended to provide the intended result when the first action did not provide the intended result

22. The user device of claim 21, wherein the at least one processor maps one or more actions to the sensor output by being further configured to rank the first action and the second action based on a likelihood of providing the intended result.

23. The user device of claim 21, wherein the operating parameter comprises a supply voltage or current, and the determined first action comprises an increase in the voltage or current supply by a first amount and the determined second action comprises an increase in the voltage or current supply by a second amount different from the first amount.

24. The user device of claim 21, wherein the operating parameter comprises a clock signal, and the determined first action comprises one of a ramp up or a ramp down in clock amplitude by a first amount and the determined second action comprises one of a ramp up or a ramp down in clock amplitude by a second amount different from the first amount.

25. The user device of claim 15, wherein the at least one processor is further configured to:
predict a hang/reset state during a subsequent occurrence of the use case, subsequent to mapping one or more sensor outputs to a use case, and mapping one or more actions to each sensor output mapped to the use case; and
implement one or more of the actions mapped to the one or more sensor outputs mapped to the use case upon predicting a hang/rest state.

26. The user device of claim 25, wherein the at least one processor predicts a hang/reset state by being further configured to:
receive one or more sensor outputs mapped to the use case;
compare the one or more of the sensor outputs to a prediction criterion indicative of a potential hang/reset state; and
determine a potential hang/reset state when the prediction criterion is satisfied.

27. The user device of claim 26, wherein a first action of the one or more actions mapped to a sensor output is implemented when the prediction criterion is satisfied.

28. The user device of claim 27, wherein the at least one processor maps one or more actions to the sensor output by being configured to:
determine if implementation of the first action affected a change in the sensor output so that the prediction criterion is no longer satisfied;
implement a second action of the one or more actions mapped to the sensor output when the prediction criterion is still satisfied; and
repeat the determining and implementing until the prediction criterion is no longer satisfied.

29. A user device having a plurality of modules for implementing one or more use cases, said user device comprising:
means for mapping one or more sensor outputs to a use case based on sensor outputs obtained during a hang/reset state of the user device during the use case, each of the one or more sensor outputs associated with one of the plurality of modules; and
means for mapping one or more actions to each sensor output mapped to the use case, wherein the one or more actions affect a change in an operating parameter of a module associated with the sensor output mapped to the use case during a hang/rest state of the user device during the use case, and the one or more actions affect a corresponding change in the sensor output mapped to the use case.

30. A computer program product stored on a computer-readable medium and comprising code that when executed on at least one processor causes the at least one processor to:
map one or more sensor outputs to a use case based on sensor outputs obtained during a hang/reset state of the user device during the use case, each of the one or more sensor outputs associated with one of the plurality of modules; and
map one or more actions to each sensor output mapped to the use case, wherein the one or more actions affect a change in an operating parameter of a module associated with the sensor output mapped to the use case during a hang/rest state of the user device during the use case, and the one or more actions affect a corresponding change in the sensor output mapped to the use case.
